(19) United States
(12) Patent Application Publication
(10) Pub. No.: US 2015/0214516 A1
(43) Pub. Date: Jul. 30, 2015

(54) SECONDARY BATTERY

(71) Applicant: SAMSUNG SDI CO., LTD., Yongin-si (KR)

(72) Inventors: Myung-Jae JANG, Yongin-si (KR); Jang-Hyun SONG, Yongin-si (KR)

(21) Appl. No.: 14/565,844

(22) Filed: Dec. 10, 2014

(30) Foreign Application Priority Data
Jan. 28, 2014 (KR) 10-2014-0010877

(51) Int. Cl. H01M 2/06; H01M 2/20; H01M 2/30

(52) U.S. Cl. CPC H01M 2/06; H01M 2/30; H01M 2/202

(57) ABSTRACT

A battery includes a case having an electrode assembly in an interior thereof, a first electrode unit having a first polarity, the first electrode unit having a first portion exposed to an exterior of the case, and having a second portion electrically coupled to the electrode assembly at a position in the interior of the case, the first and second portions being formed of different metal materials, and a resin seal molding surrounding a joining portion where the first and second portions are joined together.

### CROSS-REFERENCE TO RELATED APPLICATION

The present application claims priority under 35 U.S.C. §119 to Korean Patent Application No. 10-2014-0010877, filed on Jan. 28, 2014, in the Korean Intellectual Property Office, and entitled: “Secondary Battery,” which is incorporated by reference herein in its entirety.

### BACKGROUND

1. Field

Embodiments relate to a secondary battery.

2. Description of the Related Art

A secondary battery is generally rechargeable and dischargeable. The secondary battery is used as an energy source of a mobile device, an electric vehicle, a hybrid vehicle, an electric bicycle, an uninterruptible power supply, etc. According to the type of an external device using the secondary battery, the secondary battery may be used in the form of a single battery or in the form of a battery module obtained by connecting a plurality of secondary batteries in one unit.

A small mobile device, such as a cellular phone, may operate for a predetermined time period by using the output and capacity of a single battery. However, when an extended driving period or high-power driving is necessary, as in an electric vehicle or a hybrid vehicle, a battery module may be used due to its output and capacity. The output voltage and/or the output current of the battery module may be increased according to the number of batteries included in the battery module.

### SUMMARY

Embodiments are directed to a battery, including a case having an electrode assembly in an interior thereof, a first electrode unit having a first polarity, the first electrode unit having a first portion exposed to an exterior of the case, and having a second portion electrically coupled to the electrode assembly at a position in the interior of the case, the first and second portions being formed of different metal materials, and a resin seal molding surrounding a joining portion where the first and second portions are joined together.

The first portion may directly contact the second portion at the joining portion.

An entire contact area between the first and second portions may be enclosed by the resin seal molding.

The battery may further include a cap plate closing an opening of the case. The seal molding may be interposed between the first electrode unit and the cap plate and may electrically isolate the first electrode unit from the cap plate.

The cap plate may include a hole therein, the first electrode unit may be the cap plate via the hole, and the seal molding may seal the hole in the cap plate.

The seal molding may be molded after the first electrode unit is installed through the hole in the cap plate.

The seal molding may extend from the interior of the case to the exterior of the case.

The battery may further include a cap plate that closes an opening in the case. The joining portion may extend at least partially above the cap plate.

The first and second portions may be combined together at the joining portion using one or more selected from the group of caulking, welding, sheet metal joining, riveting, and punching.

The first portion may include a first hole and the second portion may include a second hole that overlaps the first hole, and a resin material may be disposed in the holes.

The seal molding may surround the first electrode unit where the first and second holes overlap. The seal molding may be formed of the resin material. The seal molding may be interposed between the first electrode unit and a cap plate that closes an opening of the case, and may electrically isolate the first electrode unit from the cap plate.

The first portion may be in contact with a bus bar that is electrically coupled to an adjacent battery cell. The bus bar may be formed of a metal material that is different from that of the second portion.

The battery may further include a second electrode unit electrically coupled to the electrode assembly and having a second polarity that is opposite the first polarity. The second electrode unit may extend from the interior of the case to the exterior of the case.

The second electrode unit may include a first portion and a second portion. The first and second portions may be formed of a same metal material. The first portion may be exposed to the exterior of the case. The second portion may be electrically coupled to the electrode assembly.

The first portion of the first electrode unit and each of the first and second portions of the second electrode unit may be formed of the same metal material.

First and second battery cells may be disposed adjacent to each other, each including respective first and second electrode units, and the first portion of the first electrode unit of the first battery cell may be coupled to the first portion of the second electrode unit of the second battery cell by a bus bar, and the first portion of the first electrode unit of the first battery cell, the first portion of the second electrode unit of the second battery cell, and the bus bar may be formed of the same metal material.

The electrode assembly may include first and second electrode plates and a separator therebetween. The first and second electrode plates may have respective active materials coated thereon.

The seal molding may include a first block portion, a second block portion, and a groove portion. The groove portion may be interposed between the first block portion and the second block portion. The groove portion may be engaged with a cap plate that closes an opening in the case.

The second portion may extend from the first portion in a direction substantially perpendicular from the cap plate, and the groove portion may encircle the second portion in a circumferential direction of the second portion.

### BRIEF DESCRIPTION OF THE DRAWINGS

Features will become apparent to those of skill in the art by describing in detail example embodiments with reference to the attached drawings in which:

FIG. 1 illustrates a perspective view of a secondary battery according to an example embodiment;

FIG. 2 illustrates a perspective view of a battery cell shown in FIG. 1;

FIG. 3 illustrates an exploded perspective view of the battery cell shown in FIG. 2;

FIG. 4 illustrates a perspective view of main components of FIG. 3;

FIG. 5 illustrates a cross-sectional view taken along line V-V of FIG. 4;

FIGS. 6 to 8 illustrate cross-sectional views showing various forms of a joining portion between an electrode terminal and a current collecting member;

FIG. 9 illustrates a cross-sectional view taken along line IX-IX of FIG. 4; and

FIG. 10 illustrates a perspective view of a comparative secondary battery.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey example implementations to those skilled in the art. In the drawing figures, the dimensions of layers and regions may be exaggerated for clarity of illustration. Like reference numerals refer to like elements throughout.

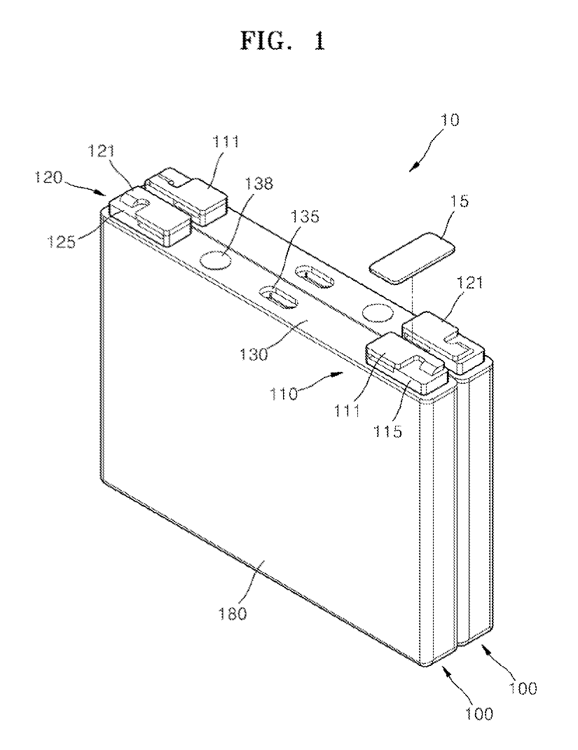

FIG. 1 shows a secondary battery 10 according to an example embodiment.

The secondary battery 10 may include at least one battery cell 100. In the example embodiment shown in FIG. 1, the secondary battery 10 may include first and second battery cells 100 that are electrically connected to each other. The first and second battery cells 100 may be disposed to neighbor each other in an arrangement direction, and may be electrically connected to each other through a busbar 15.

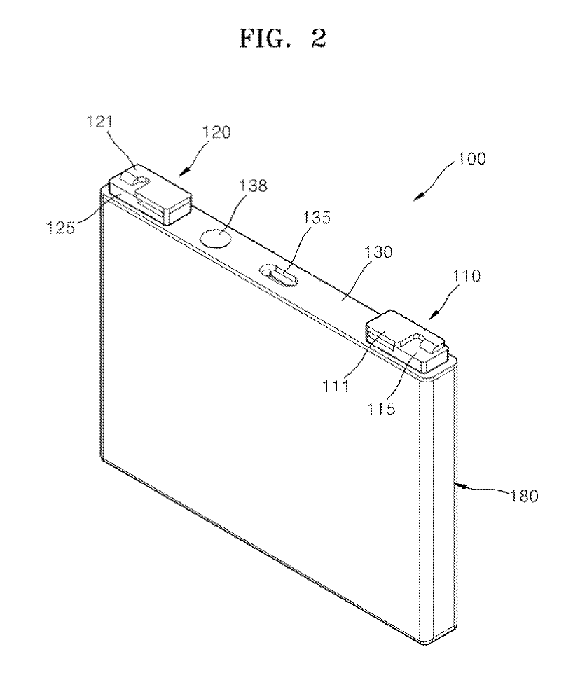

FIG. 2 shows a battery cell 100 shown in FIG. 1.

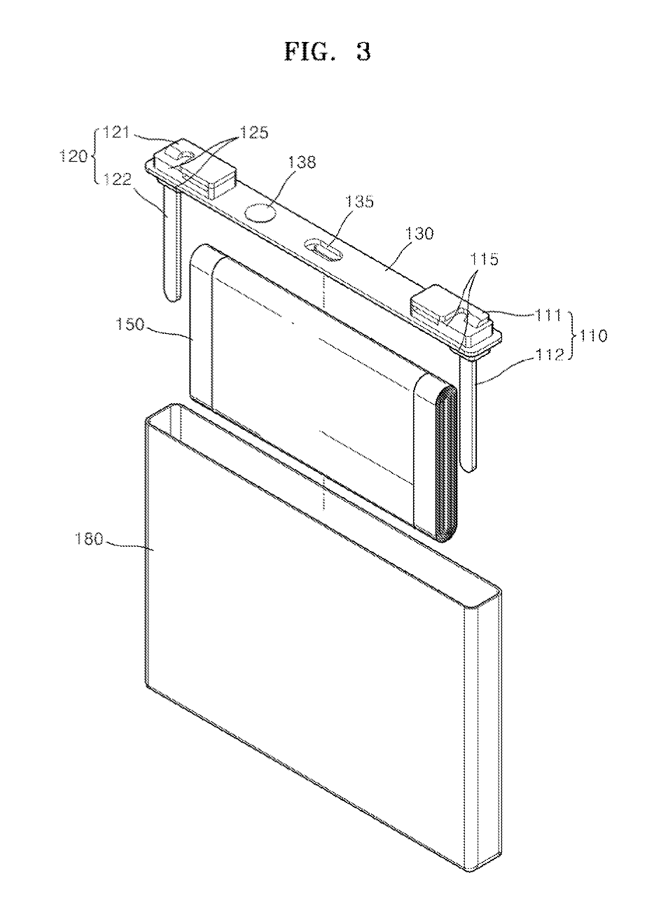

Referring to FIG. 2, the battery cell 100 may include a case 180 that contains an electrode assembly 150 (see FIG. 3), a cap plate 130 that seals the case 180, and electrode terminals 111 and 121 that are disposed on the cap plate 130. The electrode terminals 111 and 121 may include a pair of first and second electrode terminals 111 and 121 having different polarities.

The cap plate 130 includes a vent portion 135 for releasing the internal pressure by rupturing (upon an abnormal operation, in which the internal pressure of the case 180 exceeds a previously set point), and an electrolyte injection hole sealing 138 for sealing an electrolyte injection hole.

FIG. 3 shows an exploded perspective view of the battery cell 100 shown in FIG. 2.

Referring to FIG. 3, the electrode assembly 150 may be accommodated in the case 180. The electrode assembly 150 may include first and second electrode plates having opposite polarities, and a separator interposed between the first and second electrode plates. The electrode assembly 150 may be formed as a roll type, in which the first and second electrodes and the separator are rolled in a jelly-roll shape, or as a stack type, in which the first and second electrodes and the separator are alternately stacked.

The cap plate 130 is coupled onto an upper opening, in which the electrode assembly 150 is accommodated, to seal the electrode assembly 150. The electrode terminals 111 and 121 electrically connected to the electrode assembly 150 may be formed at the outside of cap plate 130 for an electric connection between the electrode assembly 150 and an external circuit (not shown) or between the electrode assembly 150 and the neighboring battery cell 100. The electrode terminals 111 and 121 may include the first electrode terminal 111 and the second electrode terminal 121 having different polarities, and may be electrically connected to the first and second electrode plates of the electrode assembly 150, respectively.

For example, the first and second electrode terminals 111 and 121 may be electrically connected to the electrode assembly 150 accommodated in the case 180, and may be electrically connected to the first and second electrode plates of the electrode assembly 150 and function as negative and positive terminals, respectively. For example, the first and second electrode terminals 111 and 121 may be formed on both the left and right sides of the electrode cell 100, respectively.

The first and second electrode terminals 111 and 121 constitute parts of first and second electrode units 110 and 120. For example, the first and second electrode units 110 and 120 may constitute an electric path extending from the electrode assembly 150 so as to supply discharge power accumulated in the electrode assembly 150 to the outside, or may constitute an electric path connected to the electrode assembly 150 so as to receive recharging power from the outside.

The first and second electrode units 110 and 120 may constitute negative and positive electrodes of the battery cell 100. The first and second electrode units 110 and 120 may be formed to have substantially the same structure. The technical specifications of the electrode units 110 and 120 that will be described below may be applied to the first and second electrode units 110 and 120 in common. In other embodiments, the following technical specifications may be only applied to one electrode unit 110 or 120 selected from between the first and second electrode units 110 and 120.

The structure of the first electrode unit 110 will be described below first, and then the second electrode unit 120 will be described.

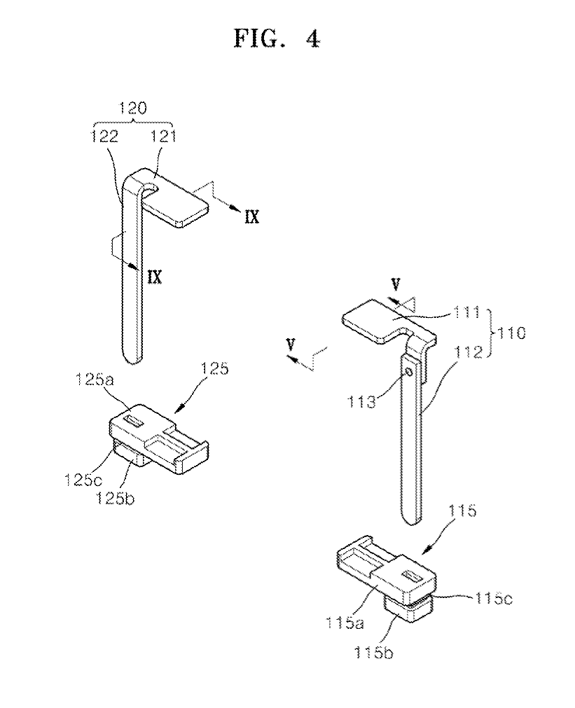

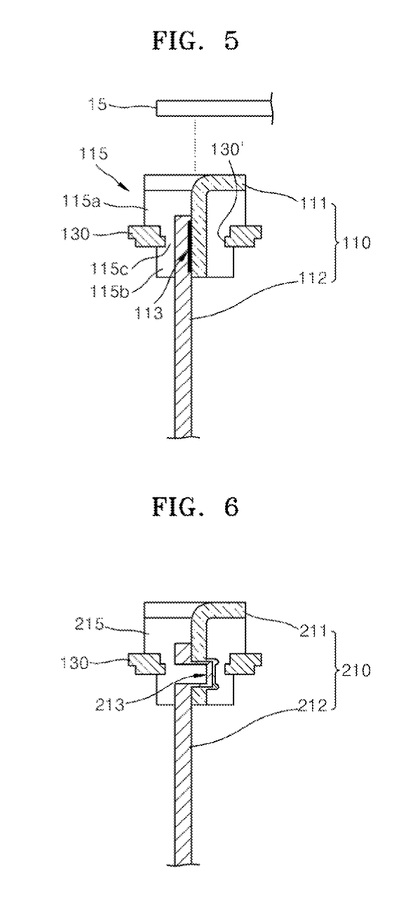

FIG. 4 is an exploded perspective view of main components shown in FIG. 3. FIG. 5 is a cross-sectional view taken along line V-V of FIG. 4.

Referring to FIGS. 4 and 5, the electrode unit 110 is assembled to penetrate an opening 130′ of the cap plate 130. Between the electrode unit 110 and the cap plate 130, a seal molding 115 is interposed. The electrode unit 110 includes the electrode terminal 111 (corresponding to the first electrode terminal) disposed on the cap plate 130 and a current collecting member 112 (corresponding to a first current collecting member) that electrically connects the electrode terminal 111 and the electrode assembly 150. For example, the electrode terminal 111 may be formed of a first metal material, and the current collecting member 112 may be formed of a second metal material different from the first metal material. Thus, the electrode terminal 111 and the current collecting member 112 may be respectively formed of the first and second metal materials different from each other, and may form a joint between different kinds of metals at a joining portion 113.

Regarding connection to the busbar 15, when the electrode terminal 111 is formed of a metal material different from that of the current collecting member 112, a joint between the electrode terminal 111 and the busbar 15 may be formed of the same kind of metals. For example, when both the electrode terminal 111 and the busbar 15 are formed of the first metal material, that is, the same material, the joint between the electrode terminal 111 and the busbar 15 may be formed of the same kind of metals.

The current collecting member 112 may be formed of the second metal material different from the first metal material for a stable connection with the electrode assembly 150. Thus, while a joint between different kinds of metals may be formed between the current collecting member 112 formed of the second metal material and the electrode terminal 111 formed of the first metal material, a joint between the same kind of metals may be formed between the electrode terminal 111 formed of the first metal material and the busbar 15 formed of the first metal material.

As a detailed example, when the first electrode unit 110 constitutes a negative electrode, the current collecting member 112 may be formed of a copper material and the electrode terminal 111 may be formed of an aluminum material, so that a joint between different kinds of metals (joining portion 113) is formed between the current collecting member 112 and the electrode terminal 111. In this way, a joint between different kinds of metals (joining portion 113) is formed between the current collecting member 112 formed of copper and the electrode terminal 111 formed of aluminum, and as will be described below, the current collecting member 112 and the electrode terminal 111 may be joined to each other by, e.g., a caulking method such as Tox sheet metal joining or riveting, or by welding, etc.

Both the electrode terminal 111 and the busbar 15 may be formed of an aluminum material, that is, the same material, so that a joint between the same kind of metals may be formed between the electrode terminal 111 and the busbar 15.

The electrode terminal 111 and the current collecting member 112 are joined to each other at the joining portion 113. At the joining portion 113, the electrode terminal 111 and the current collecting member 112 may be joined to each other by various joining techniques, such as sheet metal joining (Tox), riveting, caulking, or welding.

FIGS. 5 to 8 show various forms of a joining portion between the electrode terminal 111 and the current collecting member 112.

In the example embodiment shown in FIG. 5, the electrode terminal 111 and the current collecting member 112 may be joined to each other by welding. For example, two members to be joined, that is, the electrode terminal 111 and the current collecting member 112, may be disposed to overlap each other, and a welding process may be applied to an overlapping portion thereof so that the electrode terminal 111 and the current collecting member 112 are joined together. In the welding process, various welding methods, such as ultrasonic welding, laser welding, and resistance welding, may be employed.

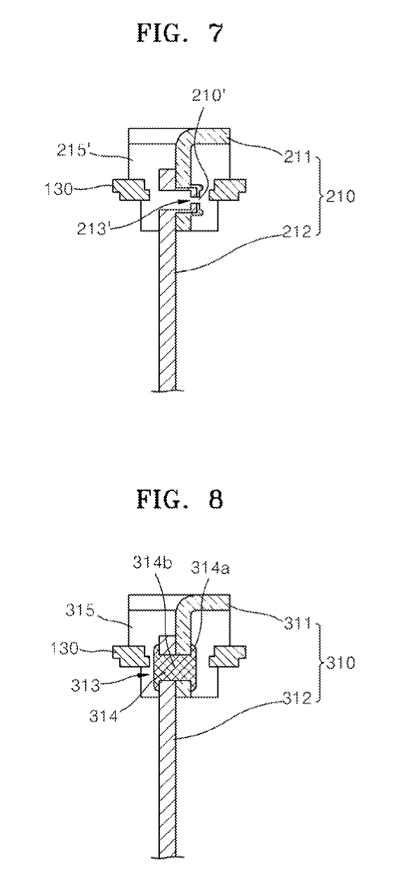

In the example embodiment shown in FIG. 6, a joining portion 213 may be formed by sheet metal joining (Tox). Thus, an electrode terminal 211 and a current collecting member 212 may be joined to each other by sheet metal joining (Tox). For example, after the two members to be joined, that is, the electrode terminal 211 and the current collecting member 212, are disposed to overlap each other, a shaping tool (not shown), such as a press punch, may be positioned on any one side of an overlapping portion thereof, a die (not shown) having a concave groove may be positioned on another side, and then the shaping tool may be pressed with a predetermined pressure. Thus, the members 211 and 212 overlapping each other may be driven into the concave groove of the die and be fixed to each other, thereby constituting a joint. Reference numeral 215 indicates a seal molding, and technical specifications thereof will be described in detail below. Reference numeral 210 indicates a first electrode unit.

FIG. 7 shows a modified embodiment of the joining portion 213 shown in FIG. 6.

Referring to FIG. 7, a joining portion 213′ of this example embodiment may be formed by sheet metal joining (Tox) as that of FIG. 6. Further, in this embodiment, the two members to be joined, that is, the electrode terminal 211 and the current collecting member 212, may be disposed to overlap each other, and holes 210′ may be formed at an overlapping portion thereof. Then, insert injection molding may be performed so that a seal molding 215′ may be formed, and molding resin may be injected through the aligned holes 210′ of the electrode terminal 211 and the current collecting member 212. The molding resin injected through the holes 210′ of the electrode terminal 211 and the current collecting member 212 may increase joining strength. The hole forming and sheet metal joining may be simultaneously performed by applying a predetermined pressure to the electrode terminal 211 and the current collecting member 212 interposed between the shaping tool (not shown) and the die (not shown), or may be performed through separate processes. Reference numeral 215′ indicates the seal molding, and will be described in detail below.

Referring to FIG. 8, an electrode terminal 311 and a current collecting member 312 may be joined to each other (joining portion 313) through a riveting or caulking process. Thus, the electrode terminal 311 and the current collecting member 312 may be joined to each other (joining portion 313) by riveting or caulking.

As shown in the drawing, the two members to be joined, that is, the electrode terminal 311 and the current collecting member 312, may be disposed to overlap each other and then aligned so that joint holes respectively formed in the electrode terminal 311 and the current collecting member 312 correspond to each other. Subsequently, a rivet member 314 may be inserted into the joint holes of the electrode terminal 311 and the current collecting member 312. A shaping tool (not shown), such as a hammer, may be positioned on one end side of the rivet member 314, and a die (not shown) may be positioned on the other end side of the rivet member 314. Then, end portions of the rivet member 314 may be pressed around the joint holes by hammering the rivet with the shaping tool so that the two members 311 and 312 are pressed and joined together.

For example, the rivet member 314 may have head portions 314a having a large diameter and a body portion 314b having a small diameter. By hammering ends of the body portion 314b, a predetermined pressure may be applied to the ends of the body portion 314b so that the head portions 314a having a larger diameter than the joint holes may be formed at the ends of the body portion 314b. In this way, the members 311 and 312 may be fixed together between the two head portions 314a and may be joined together. Reference numeral 315 indicates a seal molding, and will be described in detail below. Reference numeral 310 indicates a first electrode unit.

As described above, the electrode terminal 111 and the current collecting member 112 may constitute the joining portion 113 by various joining methods. Methods besides those particularly described herein may also be used, and thus the joining portion 113 may be formed by various joining methods.

The seal molding 115 (corresponding to a first seal molding) is described now with reference to FIGS. 4 and 5. The joining portion 113 between the electrode terminal 111 and the current collecting member 112 may be surrounded by the seal molding 115. The seal molding 115 may surround the joining portion 113 between the electrode terminal 111 and the current collecting member 112, and may further improve a joining strength between different kinds of metals. A joint strength between different kinds of metals may be relatively low due to material characteristics. Thus, the joining strength of the joining portion 113 may be improved by surrounding the joining portion 113 between the different kinds of metals with the seal molding 115.

The joining portion 113 between the electrode terminal 111 and the current collecting member 112 may be surrounded and sealed by the seal molding 115. The seal molding 115 may cover and protect the joining portion 113 including an interface between the different kinds of metals and blocks infiltration of moisture, which may help prevent corrosion at a dissimilar metal interface. For example, the seal molding 115 may insulate the joining portion 113 between the electrode terminal 111 and the current collecting member 112 from surroundings, which may help prevent corrosion of the joining portion 113.

Referring to FIG. 5, the electrode unit 110 including the electrode terminal 111 and the current collecting member 112 may be installed to penetrate the cap plate 130 through the opening 130′ of the cap plate 130. The seal molding 115 may be interposed between the electrode terminal 111 and the cap plate 130. For example, the seal molding 115 may be interposed between the electrode terminal 111 and the cap plate 130 to join them together, and may serve to fix a position of the electrode unit 110 with respect to the cap plate 130.

The seal molding 115 may be interposed between the electrode terminal 111 and the cap plate 130 to electrically insulate them from each other. For example, the electrode terminal 111 and the cap plate 130 may have different polarities, and may be electrically insulated from each other by interposing the seal molding 115 therebetween. For example, the seal molding 115 may be formed of a polymer resin material having an electrically insulating characteristic.

The seal molding 115 may completely seal the opening 130′ of the cap plate 130 penetrated by the electrode unit 110. For example, the seal molding 115 may seal the electrode assembly 150 and an electrolyte (not shown) contained in the case 180, and protect them from external harmful substances.

As an example, by inserting the electrode unit 110 in the opening 130′ of the cap plate 130 and then injecting molding resin (not shown) between the opening 130′ and the electrode unit 110, the seal molding 115 may be formed. For example, the seal molding 115 may be formed by insert injection molding. The cap plate 130, in which the electrode unit 110 is inserted, may be positioned in a mold (not shown) into which molding resin will be injected. Then, by insert injection molding for temporarily fixing the electrode unit 110 and the cap plate 130 in the mold and injecting molding resin into the mold, the seal molding 115 as shown in FIG. 5 may be formed. At this time, the injected molding resin may completely fill the gap between the cap plate 130 and the electrode unit 110 and may be airtightly interposed therebetween. In this way, the electrode assembly 150 and an electrolyte (not shown) contained in the case 180 may be sealed, and infiltration of external harmful substances into the case 180 or leakage of the internal electrolyte may be prevented.

Referring to FIGS. 4 and 5, the seal molding 115 may include a joint groove portion 115c located in the opening 130′ of the cap plate 130, an upper block 115a on the joint groove portion 115c, and a lower block 115b under the joint groove portion 115c. The joint groove portion 115c may constitute a neck portion that has the smallest width in the seal molding 115. The upper block 115a having a relatively large width and the lower block 115b are disposed on and under the joint groove portion 115c, so that the cap plate 130 may be firmly located in the joint groove portion 115c.

The seal molding 115 may be seamlessly formed as one body. For example, the joint groove portion 115c, the upper block 115a, and the lower block 115b of the seal molding 115 may be seamlessly connected in one body, and the respective portions may be simultaneously formed together by insert injection molding.

The upper block 115a may be interposed between the electrode terminal 111 and the cap plate 130, and may insulate the electrode terminal 111 from the cap plate 130.

The joining portion 113 between the electrode terminal 111 and the current collecting member 112 may be surrounded by at least the joint groove portion 115c and the lower block 115b. For example, the joining portion 113 may extend over the joint groove portion 115c and the lower block 115b, and the joint groove portion 115c and the lower block 115b may surround the joining portion 113 to protect the dissimilar metal interface from corrosion and improve a joining strength. In various example embodiments, the joining portion 113 may be formed over the joint groove portion 115c, the upper block 115a, and the lower block 115b, and the joint groove portion 115c, the upper block 115a, and the lower block 115b all may surround and protect the joining portion 113 of the electrode terminal 111 and the current collecting member 112 in cooperation.

The second electrode unit 120 is described now.

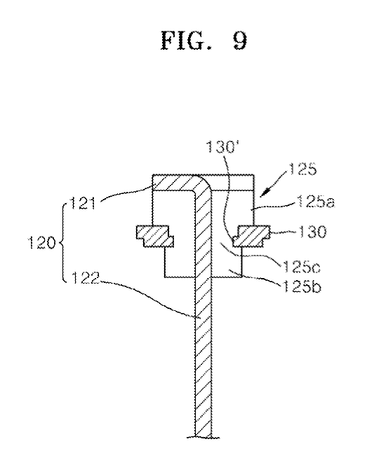

FIG. 9 shows a cross-sectional view taken along line IX-IX of FIG. 4.

Referring to FIG. 9, the second electrode unit 120 includes the electrode terminal 121 (corresponding to the second electrode terminal) disposed on the cap plate 130 and a current collecting member 122 (corresponding to a second current collecting member) that electrically connects the electrode terminal 121 and the electrode assembly 150. For example, the electrode terminal 121 and the current collecting member 122 may be formed in one body as one member. Thus, the electrode terminal 121 and the current collecting member 122 may be seamlessly connected.

For example, when the second electrode unit 120 constitutes a positive electrode, the electrode terminal 121 and the current collecting member 122 may be formed of an aluminum material and formed as one member in one body.

The electrode unit 120 may be assembled to penetrate the opening 130′ of the cap plate 130, and a seal molding 125 (corresponding to a second seal molding) may be interposed between the electrode unit 120 and the cap plate 130.

Referring to FIGS. 4 and 9 together, the seal molding 125 may include a joint groove portion 125c that is located in the cap plate 130, and an upper block 125a and a lower block 125b that are on and under the joint groove portion 125c. The joint groove portion 125c may constitute a neck portion that has the smallest width in the seal molding 125. The upper block 125a having a relatively large width and the lower block 125b are disposed on and under the joint groove portion 125c so that the joint groove portion 125c may be firmly located in the cap plate 130.

The seal molding 125 may be seamlessly formed as one body. For example, the joint groove portion 125c, the upper block 125a, and the lower block 125b of the seal molding 125 may be seamlessly connected in one body, and the respective portions may be simultaneously formed together by insert injection molding.

The upper block 125a may electrically insulate the electrode terminal 121 disposed on the cap plate 130 and the cap plate 130 from each other.

Referring to FIGS. 5 and 9 together, the seal moldings 115 and 125 (first and second seal moldings) of the first and second electrode units 110 and 120 may be formed in substantially the same shape. In an example embodiment, there may be a functional difference in that the seal molding 115 of the first electrode unit 110 functions to surround and protect the joining portion 113 between the electrode terminal 111 and the current collecting member 112 that are formed of different kinds of metals, whereas the seal molding 125 of the second electrode unit 120 covers a part of the electrode terminal 121 and the current collecting member 122 that are formed in one body.

Referring to FIG. 1, the whole busbar 15, which electrically connects the battery cells 100 neighboring each other in the arrangement direction, may be formed of the first metal material. The electrode terminals 111 and 121 of the respective battery cells 100 connected to the busbar 15 may also be formed of the first metal material. In this way, the electrode terminals 111 and 121 of the neighboring battery cells 100 and the busbar 15 may all be formed of the first metal material, that is, the same kind of materials, so that a connection structure of the busbar 15 may be formed as a similar-metal junction. In an example embodiment, the neighboring electrode terminals 111 and 121 and the busbar 15 may be formed of an aluminum material.

For example, a joint between the first electrode terminal 111 and the busbar 15, and a joint between the second electrode terminal 121 and the busbar 15, may be formed by welding between the same kind of metals. In an example embodiment, the joints between the first and second electrode terminals 111 and 121 and the busbar 15 may be formed by aluminum welding. As will be described below, aluminum welding may provide better weldability than copper welding, and thus may be advantageous in terms of production yield rate and weld strength.

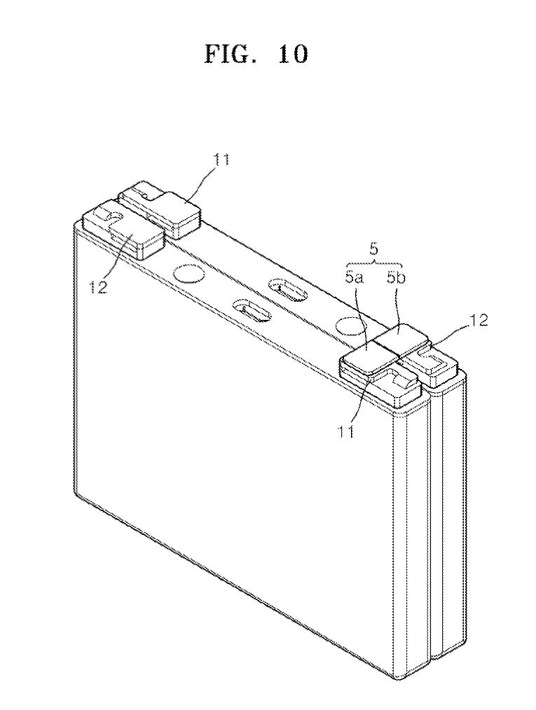

FIG. 10 shows a connection structure of a busbar 5 according to a comparative example.

Referring to FIG. 10, the busbar 5 that electrically connects neighboring battery cells may be formed of a clad metal of different kinds of metals. For example, the busbar 5 may include a first portion 5a (formed of a first metal material, of the same kind as that of a first electrode terminal 11), and a second portion 5b (formed of a second metal material, of the same kind as that of a second electrode terminal 12). The busbar 5 and the first electrode terminal 11 may constitute a similar-metal junction of the first metal material, and the bulbar 5 and the second electrode terminal 12 may constitute a similar-metal junction of the second metal material.

For example, similar-metal welding of copper may be performed between the busbar 5 and the first electrode terminal 11, and similar-metal welding of aluminum may be performed between the busbar 5 and the second electrode terminal 12. However, copper-copper weld strength may be significantly lower than aluminum-aluminum weld strength. Thus, the connection structure of the busbar 5 according to the comparative example involves copper-copper welding, and the low weldability due to material characteristics may require a special welding technology and make it difficult to ensure sufficient weld strength.

In an example embodiment, the first and second electrode terminals 111 and 121 and the busbar 15 all are formed of an aluminum material, so that copper-copper welding may be avoided, and aluminum-aluminum welding which shows better weldability may be used.

As shown in FIG. 1, the busbar 15 electrically connects the neighboring battery cells 100. By connecting the electrode terminals 111 and 121 having opposite polarities with the busbar 15, the neighboring battery cells 100 may be connected in series. In other embodiments, by connecting the electrode terminals 111 and 121 having the same polarity with the busbar 15, the neighboring battery cells 100 may be connected in parallel.

As described above, embodiments may provide a secondary battery in which a terminal unit including a joining portion between different kinds of metals has improved corrosion resistance and joint strength. Embodiments may provide a secondary battery in which a busbar electrically connecting neighboring battery cells has an improved connection structure, which may avoid difficulties weldability due to material characteristics. Embodiments may provide a secondary battery in which the corrosion resistance and joining strength of a terminal unit including a joining portion between different kinds of metals are improved.

### DESCRIPTION OF REFERENCE NUMERALS

10: secondary battery
100: battery cell
110, 210, and 310: first electrode unit
111: first electrode terminal
112: first current collecting member
113, 213, 213′, and 313: joining portion
115, 115′, 215, 215′, and 315: first seal molding
115a: upper block of first seal molding
115b: lower block of first seal molding
115c: joint groove portion of first seal molding
120: second electrode unit
121: second electrode terminal
122: second current collecting member
125: second seal molding
125a: upper block of second seal molding
125b: lower block of second seal molding
125c: joint groove portion of second seal molding
130: cap plate
130′: opening of cap plate
135: vent portion
138: electrolyte injection hole sealing
150: electrode assembly
180: case
314: rivet member

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery, comprising:
a case having an electrode assembly in an interior thereof;
a first electrode unit having a first polarity, the first electrode unit having a first portion exposed to an exterior of the case, and having a second portion electrically coupled to the electrode assembly at a position in the interior of the case, the first and second portions being formed of different metal materials; and
a resin seal molding surrounding a joining portion where the first and second portions are joined together.

2. The battery as claimed in claim 1, wherein the first portion directly contacts the second portion at the joining portion.

3. The battery as claimed in 2, wherein an entire contact area between the first and second portions is enclosed by the resin seal molding.

4. The battery as claimed in 1, further comprising a cap plate closing an opening of the case, wherein the seal molding is interposed between the first electrode unit and the cap plate and electrically isolates the first electrode unit from the cap plate.

5. The battery claimed in 4, wherein the cap plate includes a hole therein, the first electrode unit penetrating the cap plate via the hole, the seal molding sealing the hole in the cap plate.

6. The battery as claimed in 5, wherein the seal molding is molded after the first electrode unit is installed through the hole in the cap plate.

7. The battery as claimed in claim 1, wherein the seal molding extends from the interior of the case to the exterior of the case.

8. The battery as claimed in claim 7, further comprising a cap plate that closes an opening in the case, wherein the joining portion extends at least partially above the cap plate.

9. The battery as claimed in claim 1, wherein the first and second portions are combined together at the joining portion using one or more selected from the group of caulking, welding, sheet metal joining, riveting, and punching.

10. The battery as claimed in claim 1, wherein the first portion includes a first hole and the second portion includes a second hole that overlaps the first hole, and a resin material is disposed in the holes.

11. The battery as claimed in 10, wherein the seal molding surrounds the first electrode unit where the first and second holes overlap, the seal molding being formed of the resin material, the seal molding being interposed between the first electrode unit and a cap plate that closes an opening of the case, the seal molding electrically isolating the first electrode unit from the cap plate.

12. The battery as claimed in claim 1, wherein the first portion is in contact with a bus bar that is electrically coupled to an adjacent battery cell, the bus bar being formed of a metal material that is different from that of the second portion.

13. The battery as claimed in claim 1, further comprising a second electrode unit electrically coupled to the electrode assembly and having a second polarity that is opposite the first polarity, the second electrode unit extending from the interior of the case to the exterior of the case.

14. The battery as claimed in claim 13, wherein the second electrode unit includes a first portion and a second portion, the first and second portions being formed of a same metal material, the first portion being exposed to the exterior of the case, the second portion being electrically coupled to the electrode assembly.

15. The battery as claimed in claim 14, wherein the first portion of the first electrode unit and each of the first and second portions of the second electrode unit are formed of the same metal material.

16. The battery as claimed in claim 14, wherein:
first and second battery cells are disposed adjacent to each other, each including respective first and second electrode units, and the first portion of the first electrode unit of the first battery cell is coupled to the first portion of the second electrode unit of the second battery cell by a bus bar, and
the first portion of the first electrode unit of the first battery cell, the first portion of the second electrode unit of the second battery cell, and the bus bar are formed of the same metal material.

17. The battery as claimed in claim 1, wherein the electrode assembly includes first and second electrode plates and a separator therebetween, the first and second electrode plates having respective active materials coated thereon.

18. The battery as claimed in claim 1, wherein the seal molding includes a first block portion, a second block portion, and a groove portion, the groove portion being interposed between the first block portion and the second block portion, the groove portion being engaged with a cap plate that closes an opening in the case.

19. The battery as claimed in claim 18, wherein the second portion extends from the first portion in a direction substantially perpendicular from the cap plate, and the groove portion encircles the second portion in a circumferential direction of the second portion.
